(19) United States
(12) Patent Application Publication
(10) Pub. No.: US 2015/0014132 A1
(43) Pub. Date: Jan. 15, 2015

(54) SWITCHING DEVICE HAVING AN EXTERNAL MODULE

(71) Applicant: EATON ELECTRICAL IP GMBH & CO. KG, Schoenefeld (DE)

(72) Inventors: Georg Reidt, Swisttal (DE); Johann Skupin, Niederkassel (DE); Lothar Jagusch, Bonn (DE)

(73) Assignee: EATON ELECTRICAL IP GMBH & CO. KG, Schoenefeld (DE)

(21) Appl. No.: 14/378,662

(22) PCT Filed: Feb. 15, 2013
(86) PCT No.: PCT/EP2013/053113

§ 371 Date: Aug. 14, 2014

(30) Foreign Application Priority Data
Feb. 15, 2012 (EP) 12155648.4

(51) Int. Cl. H01H 9/16; H01H 3/12; H01H 9/02

(52) U.S. Cl. CPC H01H 9/161; H01H 9/0271; H01H 3/12; H01H 2221/024; H01H 2219/039; H01H 2219/046; H01H 2223/008; H01H 2231/032
USPC 200/293

(57) ABSTRACT

A switching device, wherein the switching device has a switch cabinet, which has a switch cabinet housing, a switching apparatus that is attached in the switch cabinet, and an external module. The external module is attached to the switch cabinet housing and connected to the switching apparatus. The external module also comprises a display element and/or an operating element. The display element is visible from outside of the switch cabinet housing, and the operating element can be operated from outside of the switch cabinet housing.

### CROSS-REFERENCE TO RELATED APPLICATIONS

This application is a U.S. National Stage application under 35 U.S.C. §371 of International Application No. PCT/EP2013/053113, filed on Feb. 15, 2013, and claims benefit to European Patent Application No. 12155648.4, filed on Feb. 15, 2012. The International Application was published in German on Aug. 22, 2013, as WO 2013/121014 A1 under PCT Article 21(2).

### FIELD

The invention relates to a switching device, wherein the switching device comprises a switch cabinet, which has a switch cabinet housing, a switching apparatus that is attached in the switch cabinet, and an external module.

### BACKGROUND

Conventional switching apparatuses normally have a display element to display the status of the switching apparatus and an operating element to control its operating parameters. The display element and the operating element are typically arranged on the switching apparatus and rigidly connected thereto. Such an arrangement of the display and operating element then proves to be disadvantageous if the switching apparatus is installed in a switch cabinet. The display element is often hidden by a switch cabinet housing so that the operating parameters of the switching apparatus cannot be determined. Furthermore, the switch cabinet housing restricts access to the operating element. The switching apparatus is therefore possibly not accessible to be able to control it.

DE 10 2005 016 544 A1 discloses a module front for a switching system module to be installed in a switch cabinet. The module front comprises display and operating elements as well as an interface that is suitable for providing retrievable status information regarding the switching system module, for example via means to a wireless communication. The module front is an integral component of the switching system module and forms part of the housing of the switching system module. The disadvantage with this solution is that the switch cabinet housing, which is normally made of metal and surrounds the module front, can interfere considerably with the wireless communication.

### SUMMARY

An aspect of the invention provides a switching device, comprising: a switch cabinet including a switch cabinet housing; a switching apparatus, which is attached in the switch cabinet; an external module, which is attached to the switch cabinet housing; and at least one of (a) a display element, which is visible from outside the switch cabinet housing, or (b) an operating element, which can be operated from outside the switch cabinet housing, wherein the external module is attached to the switch cabinet housing, and wherein the external module is configured to be connectible to the switching apparatus.

### BRIEF DESCRIPTION OF THE DRAWINGS

The present invention will be described in even greater detail below based on the exemplary figure. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows the switching device according to the invention in a schematic view.

### DETAILED DESCRIPTION

An aspect of the present invention is therefore to improve a switching device having a switching apparatus and a switch cabinet for receiving the switching apparatus, such that it is easy to retrieve the operating parameters of the switching apparatus located in the switch cabinet and to operate the switching apparatus.

In detail, the switching device comprises a switch cabinet having a switch cabinet housing, a switching apparatus that is attached in the switch cabinet, and an external module. The switching apparatus is not necessarily arranged fully inside an interior defined by the switch cabinet housing. Individual components of the switching apparatus, for example a switch lever, may engage through the switch cabinet housing, such that they are accessible from outside the switch cabinet housing. The external module is attached to the switch cabinet housing. Preferably the external module is arranged such that it projects at least in part out of the switch cabinet housing. The external module comprises a display element and/or an operating element. The display element and/or the operating element are arranged on the external module such that they are easily accessible to a person located outside the switch cabinet. The display element is visible from outside the switch cabinet housing and the operating element can be operated from outside the switch cabinet housing. Preferably the display and/or operating elements are arranged outside the interior of the switch cabinet housing. In addition to this the external module is connected to the switching apparatus, for example via a suitable connecting cable and correspondingly suitable interfaces on the switching apparatus and the external module.

Preferably the switch cabinet housing comprises a switch cabinet door such that the external module can be attached to the switch cabinet door.

It is advantageous for the display element to have a multicolored display. In a preferred embodiment of the invention the display element comprises a multicolored LED. By using the multicolored LED a color display depending on an operating parameter of the switching apparatus is possible. In particular different colors depending on the operating parameter such as the current and/or voltage and/or temperature can be displayed by multicolor LED. Such a solution provides the advantage of displaying different operating conditions of the switching apparatus depending on the operating parameter of the switching apparatus without taking up additional installation space, which is the case when using a plurality of single color LEDs. The display of the operating condition may for example entail the display of whether the current, relative to a predefined value, is less than 70%, between 70% and 100% (first operating condition), between 100% and 120% (second operating condition) or greater than 120% (third operating condition). The transition between any two operating conditions can be indicated by a change of color in the multicolored LED. The color may change in jumps or steadily. The multicolored LED can also convey additional information by flashing or otherwise changing its brightness depending on the operating parameter/operating condition. In this way an easily perceptible signalling effect can be achieved above all when the operating parameter exceeds or falls short of a predetermined limit value.

In order to assist the color display, the display element advantageously has a reference ring. The reference ring is provided in order to visually indicate an assignment of the colors that the multicolor LED can display to the associated parameter values of the switching apparatus. As a result of this, a current range corresponding to the color displayed can for example be read and recognized at a glance. The reference ring makes it possible to convey two pieces of information: a color coding on the reference ring allows a rough quantitative message based on the given color display of the multicolored LED; at the same time it also allows an intuitive and quickly readable display, for example in the event of danger. To this end the reference ring can, for example, provide a graphic indication of the assignment of the color red for a “danger” message for example and accordingly a green color for an “OK” message.

In a preferred embodiment of the invention the display element of the external module comprises an indicator light.

In another advantageous embodiment of the invention, the operating element of the external module comprises an illuminated push button. The operating element advantageously comprises means that are suitable for resetting or acknowledging the operating condition of the switching apparatus.

The external module preferably has an interface for wireless communication. The interface is preferably in the form of a Bluetooth and/or a ZigBee interface or another suitable interface. It is particularly advantageous if the external module provides retrievable information concerning the operating parameter of the switching apparatus via the interface for wireless communication. The interface preferably allows data to be exchanged with an external receiver/transmitter, which for example receives information concerning the operating parameter and/or the operating condition of the switching apparatus or conveys control commands to the switching device. A Smartphone, for example, or a portable computer or another suitable device are possibilities for such an external receiver/transmitter.

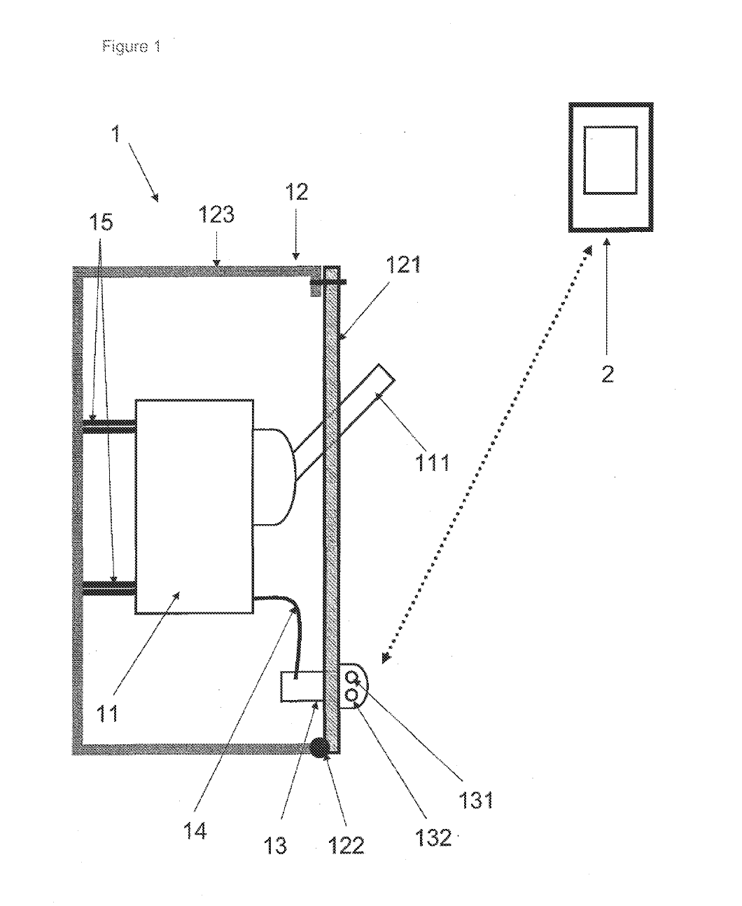

In detail, FIG. 1 shows a switching device 1 according to the invention. The switching device 1 comprises a switch cabinet, part of the switch cabinet housing 12 of which is shown in FIG. 1, a switching apparatus 11, which is attached in the switch cabinet housing 12 by means of a suitable rail element 15, and an external module 13. Furthermore, the switch cabinet housing 12 comprises a switch cabinet door 121, which is connected to a main body 123 of the switch cabinet housing 12 by means of a suitable hinge 122 such that the switch cabinet door is pivotable about a pivot axis of the hinge 122.

The switching apparatus comprises a switch lever 111, which engages through the switch cabinet housing 12. The external module 13 is attached to the switch cabinet door 121, the external module 13, extending through the switch cabinet door 121, being arranged in part outside the switch cabinet. The external module 13 is connected to the switching apparatus 11 via a connecting cable 14. The connecting cable 14 is constructed such that the connection between the switching apparatus 11 and the external module 13 is not interrupted, even when the switch cabinet door 121 is open.

Furthermore, the external module 13 comprises a display element 131, which comprises an indicator light as well as an operating element 132, which comprises an illuminated push button. The display element 131 is arranged such that it is visible from outside the switch cabinet housing 12. The operating element 132 is also arranged such that it can be operated from outside the switch cabinet housing 12. The external module 13 has an interface for wireless communication. An external receiver/transmitter 2 can exchange data with the external module 13 via a wireless connection, which is indicated in FIG. 1 by a dotted double arrow.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMERALS

1 Switching device
11 Switching apparatus
111 Switch lever
12 Switch cabinet housing
121 Switch cabinet door
122 Hinge
123 Main body of the switch cabinet housing
13 External module
131 Display element
132 Operating element
14 Connecting cable
15 Rail element
2 Receiver/transmitter

1: A switching device, comprising:
a switch cabinet including a switch cabinet housing;
a switching apparatus, which is attached in the switch cabinet;
an external module, which is attached to the switch cabinet housing;
and at least one of (a) a display element, which is visible from outside the switch cabinet housing, or (b) an operating element which can be operated from outside the switch cabinet housing,
wherein the external module is configured to be connectible to the switching apparatus.

2: The device of claim 1, wherein the switch cabinet housing includes a switch cabinet door, and
wherein the external module is attached to the switch cabinet door.

3: The device of claim 1, wherein the display element includes a multicolored LED, it being possible to display different colors depending on an operating parameter of the switching apparatus using the multicolored LED.

4: The device of claim 3, wherein the display element includes a reference ring, and
wherein the reference ring shows a dependence of a color display of the multicolored LED on the operating parameter of the switching apparatus.

5: The device of claim 1, wherein the display element includes an indicator light.

6: The device of claim 1, wherein the operating element includes an illuminated push button.

7: The device of claim 1, wherein the operating element includes a unit configured to reset or acknowledge an operating condition of the switching apparatus.

8: The device of claim 1, wherein the external module includes an interface for wireless communication.

9: The device of claim 8, wherein the interface for wireless communication is in the form of a Bluetooth or a ZigBee interface.

10: The device of claim 8, wherein the external module provides retrievable information concerning the operating parameter of the switching apparatus via the interface for wireless communication.

11: The device of claim 1, comprising the display element, which is visible from outside the switch cabinet housing.

12: The device of claim 1, comprising the operating element, which can be operated from outside the switch cabinet housing.

13: The device of claim 11, comprising the operating element, which can be operated from outside the switch cabinet housing.

14: The device of claim 7, wherein the operating element includes the unit configured to reset the operating condition of the switching apparatus.

15: The device of claim 7, wherein the operating element includes the unit configured acknowledge the operating condition of the switching apparatus.

16: The device of claim 14, wherein the operating element includes the unit configured acknowledge the operating condition of the switching apparatus.

17: The device of claim 8, wherein the interface for wireless communication is in the form of the Bluetooth interface.

18: The device of claim 8, wherein the interface for wireless communication is in the form of the ZigBee interface.
